(19) United States
(12) Patent Application Publication
(10) Pub. No.: US 2001/0043675 A1
(43) Pub. Date: Nov. 22, 2001

(54) METHOD AND APPARATUS FOR TELEPHONE LINE TESTING

(76) Inventor: THOMAS J.J. STARR, BARRINGTON, IL (US)

Correspondence Address: ARTZ & ARTZ, 28333 TELEGRAPH ROAD, SUITE 250, SOUTHFIELD, MI, 48034

(21) Appl. No.: 09/239,591

(22) Filed: Jan. 29, 1999

(51) Int. Cl. H04M 1/24; H04M 3/22

(52) U.S. Cl. 379/27.01; 379/22.03; 379/26.02; 370/248

(57) ABSTRACT

A method and apparatus for qualifying a telephone transmission line for XDSL communication services is disclosed. The system includes a modem, located at the customer premises to be connected. The modem analyzes actual signals to determine the electrical characteristics of the communication channel associated with the customer premises. The modem includes a transmitter, receiver and controller to generate test signals and receive responses. The modem then analyzes the data to generate an output value indicative of the electrical characteristics of the communication channel being tested. This output value is then displayed to a user or transmitted over the communication channel to a network. The system thereby eliminates the necessity of dispatching a technician to test the telephone line, and provides more accurate test results than those achievable at the network-side of the connection alone.

### TECHNICAL FIELD

This invention relates generally to telephone line testing and more particularly to a method and apparatus for qualifying a customer node of a public switched telephone network for digital communications services.

### BACKGROUND OF THE INVENTION

The characteristics of telephone lines vary greatly. Typical telephone lines connecting a customer premises to a public switch telephone network (PSTN) vary in terms of length, wire guage, amount of bridged tap, background noise, loading coils, and other aspects. In addition, faults may be present along the telephone lines such as: a short circuit, an open circuit, conductor leakage, a short circuit to a power line, or induction interference from a power line. The operation and communications integrity of loop transmission systems depends on the telephone line characteristics. Loop transmission systems include a plain old telephone system (POTS), and digital subscriber line services such as an integrated services digital network (ISDN), high speed digital subscriber line (HDSL), very high speed digital subscriber line (VDSL), or asymmetric digital subscriber line (ADSL). These digital subscriber line services are commonly referred to as XDSL services. Because the integrity of XDSL communications services depend on the quality of the transmission line connection, it is desirable to test the telephone line connecting a customer premises to the PSTN to determine whether the telephone line will support the desired transmission service. It is also desirable to test the line to diagnose the source of transmission faults or interference.

Presently, two methods are commonly employed to test telephone transmission lines: (1) central office or remote terminal automated line test systems, and (2) a dispatched technician with a hand-held test set. In the first case, a line test command is sent from a centralized loop maintenance system to a network terminating node (NTN) such as a local telephone switch or carrier system located in a central office or remote equipment site. In response, the NTN connects the line to be tested through a series of relays to a system that performs electrical measurements of the telephone transmission line. The results of these measurements are then reported back to the loop maintenance system.

In the second case, a technician is dispatched to connect a hand-held test set to the telephone transmission line to be tested at one of the following locations: (1) the central office main distributing frame, (2) the network interface device (NID) at the customer node, or (3) an intermediate point such as a serving area interface point. Using the hand-held test set, the technician measures the electrical characteristics of the line and reports the results of the test to the loop maintenance center. In either case, the electrical characteristics of the line are known, and a determination can then be made as to the type of digital communications services the telephone transmission line will support.

There are several shortcomings, however, with the present methods for qualifying telephone transmission lines for digital communication services. In the first case, transmission loops served from some network terminating nodes, such as digital subscriber line access multiplexers and digital loop carrier systems, may not provide metallic test access to the telephone transmission line or the line measurement unit. In the case where telephone service is not yet activated, the telephone transmission line may not be connected to an NTN at all. In these situations, it would not be possible to perform an automated line test from the network-end of the line. Furthermore, transmission loops which are connected to an NTN with a metallic test bus and a line measurement unit, may only respond to test frequencies within the sub-4 kHz band due to bandwidth limitations of the test bus or the line measurement unit. In addition, background interference noise at the customer node may be difficult to observe with testing equipment located only at the NTN.

Dispatching a technician to test the telephone transmission line has the obvious shortcoming of increasing the time and expense to provide digital communication services to customers. This results from the need for personnel to perform these tests, and the need to provide technicians with testing equipment.

The present invention overcomes the shortcomings of present telephone transmission line testing methods by providing a modem at the customer premises for testing and qualifying the customer connection to the PSTN for XDSL communication services.

### BRIEF DESCRIPTION OF THE DRAWINGS

For a more complete understanding of the invention, reference should now be had to the embodiments illustrated in greater detail in the accompanying drawings and described below by way of examples of the invention. In the drawings:

FIG. 1 is a schematic block diagram of one embodiment of the present invention used in connection with a computer located at a customer premises; and

FIG. 2 is a schematic block diagram of one embodiment of the modem for use in the telephone line testing scenario of FIG. 1.

### DETAILED DESCRIPTION OF THE PREFERRED EMBODIMENT(S)

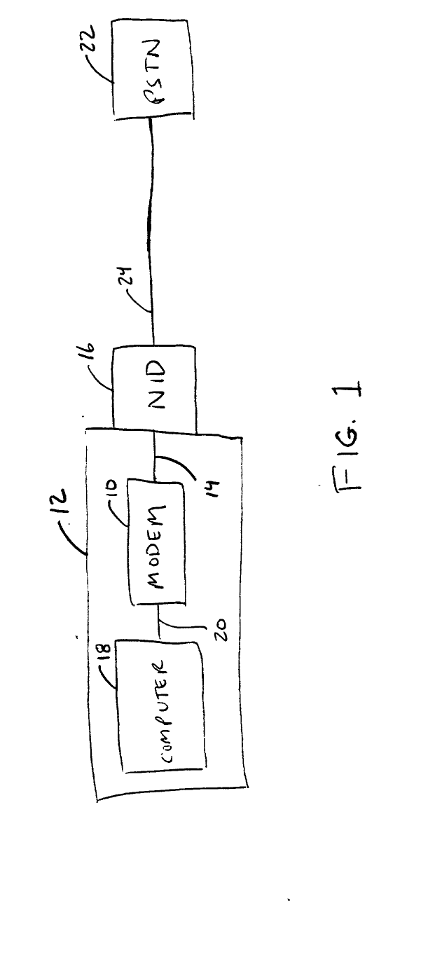

Referring to FIG. 1, there is shown a schematic block diagram of an embodiment of the present method of testing a telephone transmission line. The system shown in FIG. 1 comprises a modem 10 located at the customer premises 12 which is connected by way of transmission line 14 to the network interface device 16 at the customer premises 12. Transmission line 14 will typically comprise the modem line connected to a common telephone wall jack, and associated wiring from the wall jack to the network interface device 16. Alternatively, transmission line 14 can comprise the modem line connected directly into the network interface jack in the NID 16. It is contemplated that the modem 10 will typically be part of a digital communications device such as a computer 18 or will be connected to such a device as shown in FIG. 1 by transmission line 20. XDSL modems are commonly included in today's personal computer systems. Unlike customer end XDSL modems to date, however, modem 10 includes wideband loop testing and reporting functions. Between the network interface device 16 at the customer premises 12 and the public switch telephone network (PSTN) 22, is the telephone transmission line 24 to be tested. Of course, the PSTN could also represent a digital network.

Computer 18 is shown as part of a representative digital communications system at a customer premises 12. The modem 10 is typically a necessary part of computer 18 which allows computer 18 to transmit and receive digital signals over telephone transmission line 24. For purposes of line testing, however, computer 18 is not necessary if modem 10 is equipped with a user interface for displaying the results of the telephone transmission line test. It is to be understood that computer 18 is shown for illustration purposes and could be interchanged, for example, with other equipment that generates a communications signal to be sent over the telephone transmission line 24.

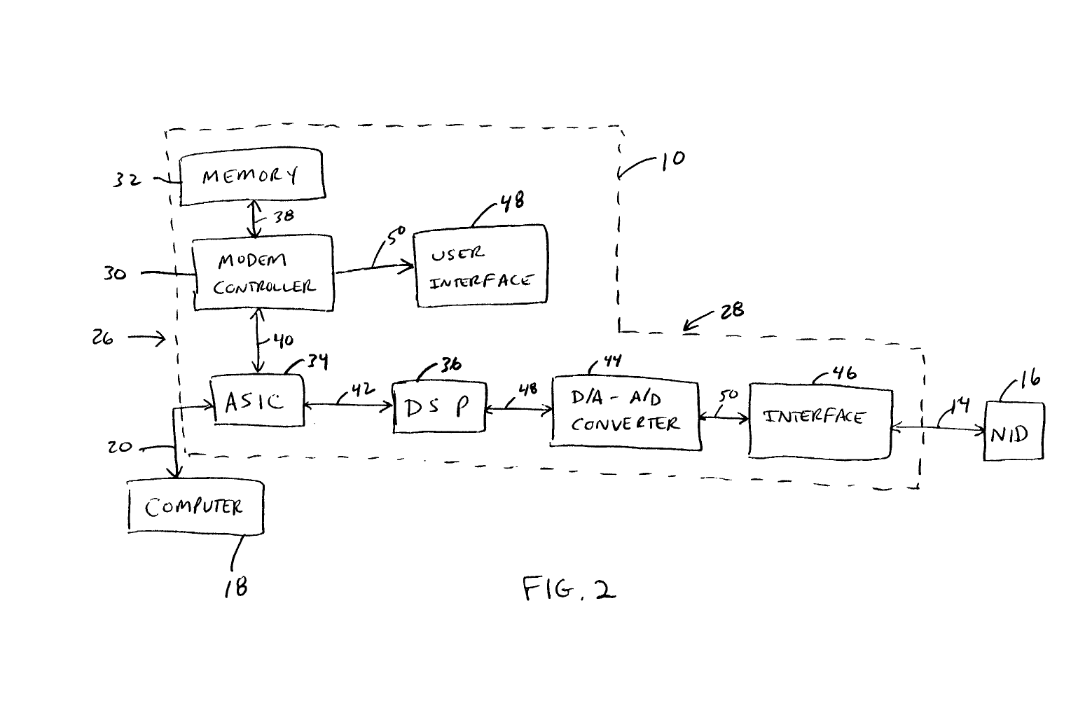

Referring to FIG. 2, an embodiment of the modem 10 comprises a transmitter/receiver 26 and direct access arrangement (DAA) 28. The transmitter/receiver 26 includes a modem controller 30 such as a microprocessor, associated memory 32, application specific integrated circuit (ASIC) 34, and a digital signal processor (DSP) 36. These components communicate along signal paths 38, 40 and 42.

The direct access arrangement 28 includes a digital-to-analog (D/A) and analog-to-digital (A/D) converter 44 and telephone interface circuitry 46. The converter 44 communicates with the DSP 36 and interface 46 along signal paths 48 and 50, respectively. The interface 46 transmits signals to and receives signals from the network interface device 16 along transmission line 14.

The modem controller 30, memory 32, ASIC 34, and DSP 36 define a transmitter for generating test signals on telephone transmission line 24. Modem controller 30, memory 32, ASIC 34 and DSP 36 also define a receiver for detecting signals in response to test signals transmitted to telephone transmission line 24.

The connection and operation of the components thus far described in modem 10 are well known.

In addition, modem 10 preferably includes a user interface 48 in communication with modem controller 30 along signal line 50 for displaying the telephone transmission line test results to a user.

In operation, customers who desire DSL services would connect the modem 10 to a wall jack at the customer premises or the network interface jack in the network interface device 16. The modem 10 performs a series of telephone line tests to qualify the line for its desired use and/or to diagnose the source of transmission interference. The test results are presented to the user by the user interface 48 or, alternatively, can be transmitted to, for example, computer 18 for display, or along transmission line 24 to a communications service provider. In this manner, the telephone transmission line 24 can be pre-qualified for the desired communications service.

To display an output indicative of the electrical characteristics of telephone transmission line 24, the modem 10 performs a series of tests. The testing sequence and logic is stored in memory 32 and executed by memory controller 30 in cooperation with transmitter/receiver 26 and DAA 28. The following functions are carried out by the modem 10 in qualifying the telephone transmission line 24. One function is line monitoring which consists of measuring background noise power in one or more frequency bands in a frequency range of approximately 0 Hz to 5 MHz. Another function is measurement of AC or DC voltage between the tip and ring, tip and ground, and ring and ground terminals of the telephone transmission line 24. Stimulus and response testing is also performed by the modem 10 in the form of transmitting test tones, receiving response signals in response to the test tones, and analyzing the amplitude and phase of the signal reflections from the transmission line 24. Aditionally, modem 10 transmits test pulses, receives response signals in response to the test pulses, and analyzes the amplitude and delay of the pulse reflections from the transmission line 24. Additional functionality includes measurement of resistance between the tip and ring, tip and ground, and ring and ground terminals of transmission line 24, as well as measurement of the capacitance between the tip and ring terminals of transmission line 24.

Depending upon the communication service desired by the customer, a series of measurements could be performed with some of the tests performed more than once, or not at all, depending on the system configuration or the results of earlier tests. In addition, or alternatively, during a test sequence, the end-user could be instructed by the modem controller 30 via the user interface 48 to perform certain actions such as to place telephones on or off hook.

At the conclusion of the sequencing and analysis, a transmission line quality value is developed as a function of the test results.

One scenario for deriving the line quality value is as follows. The user is asked to indicate the type of DSL transmission system for which the line analysis is being performed. For example: HDSL, ADSL, or ISDN. From this, assumptions are made for the typical transmitted frequency band(s), signal power, modulation method, and coding, among other things.

The broadband attenuation of the line is estimated by applying a voltage step to the line 24 and measuring the time-constant of the resulting current flow. The time-constant estimates the line capacitance, from which the line length is inferred. The estimation of the broadband attenuation could further be refined by applying a short voltage pulse to the line and measuring the number and amplitude of the observed echoed pulses. From these pulses, the presence of bridged taps can be ascertained. An additional attenuation allowance would then be made for each bridged tap. By applying a single or multiple tone frequency sweep to the line and observing the reflected signals, nonlinear distortion and the presence of a loading coil can also be detected. In addition, the background line noise would be preferably measured in one or more frequency bands. If the line response indicates the presence of a loading coil, then the line is not suitable for broadband DSL service. This would be indicated to the user or service-provider.

With knowledge of the nominal transmitted signal power and the estimated line attenuation from the measurements mentioned above, the received signal power is predicted. The noise power is predicted from the measured background noise, and the measured nonlinear distortion. A predicted signal-to-noise-ratio (SNR) value is then estimated. For a known transmission method (modulation type, transmit power, coding type, bandwidth) the achievable bit-rate is derived from the SNR. For asymmetric transmission systems (such as ADSL), a SNR estimate is derived separately for the upstream and downstream directions. Thus, a separate bit-rate capacity estimate is provided for each direction of transmission.

This bit-rate capacity is then represented as a line quality value which is then displayed to the end user by way of the user interface 48. The customer could then relay the line test results to the communications service provider. Alternatively, the test results could be transmitted to the service provider over transmission line 24.

With the preferred implementation of the line testing method, line testing would be performed in a single-ended manner. In other words, the test is conducted at the customer premises only, and no testing equipment is required at the other end of telephone transmission line 24. Of course, as an alternative implementation, a double-ended test could be performed involving coordinating testing functions at both the customer end of telephone transmission line 24 and the network end of telephone transmission line 24. In the double-ended testing scenario, test signals can be transmitted and received by the modem 10 and the PSTN 22.

The testing procedures described above can be initiated by either the end user at the customer premises or by way of an initiation message from the service provider or the local network provider via the DSL path or dial up voice band modem connection.

While the invention has been described in connection with one or more embodiments, it is to be understood that the invention is not limited to these embodiments. On the contrary, the invention covers all alternatives, modifications and equivalents as may be included within the scope and spirit of the appended claims.

What is claimed is:

1. A modem, associated with a customer premises, for analyzing electrical signals to determine the characteristics of a communication channel associated with said customer premises, said modem comprising:
a transmitter connected to said communication channel for delivering signals to said communication channel;
a receiver connected to said communication channel for receiving response signals from said communication channel; and
a modem controller having associated memory, said modem controller in operative communication with said transmitter and said receiver, said modem controller programmed to:
command said transmitter to generate test signals to stimulate said communication channel;
measure response signals received by said receiver in response to said test signals; and,
generate an output value as a function of said test signals and said response signals indicative of the electrical characteristics of said communication channel.

2. The modem of claim 1 wherein said communication channel is a telephone line having tip, ring and ground connections, respectively, and said modem controller is programmed to:
command said transmitter to generate test signals having a frequency range from approximately 0 Hz to 5 MHz to stimulate said telephone line;
measure the amplitude, phase and delay of response signals received by said receiver in response to said test signals; and,
generate an output value as a function of said test signals and said response signals indicative of the electrical characteristics of said telephone line.

3. The modem of claim 2 wherein said modem further comprises a display in communication with said modem controller for displaying said output value.

4. The modem of claim 2 wherein said modem controller is further programmed to transmit said output value to a user interface for displaying said output value to a user.

5. The modem of claim 2 wherein said modem controller is further programmed to transmit said output value over said telephone line to a network.

6. The modem of claim 2 wherein said modem controller is further programmed to measure line voltages between said tip and ring, tip and ground, and ground and ring connections, respectively.

7. The modem of claim 2 wherein said modem controller is further programmed to measure background noise in at least one frequency band between approximately 0 Hz and 5 MHz.

8. The modem of claim 2 wherein said modem controller is further programmed to measure the resistance between said tip and ring, tip and ground, and ring and ground connections respectively.

9. The modem of claim 2 wherein said modem controller is further programmed to measure the capacitance between said tip and ring connection.

10. At a customer node of a public switched telephone network comprising a telephone line associated with a customer premises, a method of qualifying said customer node for digital communication services with a modem connected to said telephone line at said customer premises, the method comprising the steps of:
transmitting with said modem a first plurality of test signals on said telephone line within a frequency range of approximately 0 Hz to 5 MHz;
measuring a second plurality of response signals with said modem received in response to said first plurality of test signals; and
generating an output value as a function of said first plurality of test signals and said second plurality of response signals indicative of the electrical characteristics of said customer node.

11. The method of claim 10 further comprising the step of transmitting said output value to a user interface for displaying said output value to a user.

12. The method of claim 10 further comprising the step of transmitting said output value over said telephone line to a network.

13. The method of claim 10 further comprising the steps of:
measuring a third plurality of response signals with said modem received in response to test signals transmitted across said public switched telephone network; and
generating an output value as a function of said first plurality of test signals, said second plurality of response signals, and said third plurality of test signals indicative of the electrical characteristics of said customer node.

14. At a customer node of a public switched telephone network comprising a modem at said customer node connected to a telephone line, a method of qualifying said customer node for digital communication services, the method comprising the steps of:
generating test signals on said telephone line within a frequency range of approximately 0 Hz to 5 MHz;
generating a first plurality of values as a function of the amplitude, phase and delay of response signals received in response to said test signals;
generating a second plurality of values indicative of the line voltages between the tip and ring, tip and ground, and ground and ring connections, respectively of said telephone line;
generating a third plurality of values indicative of the resistance between the tip and ring, tip and ground, and ring and ground connections, respectively of said telephone line;
generating a fourth values indicative of the capacitance between the tip and ring connection of said telephone line;
generating a fifth value indicative of the background noise in at least one frequency band between approximately 0 Hz and 5 MHz; and
generating an output value as a function of said first, second, third, fourth and fifth values indicative of the electrical characteristics of said customer node.

15. The method of claim 13 further comprising the step of transmitting said output value to a user interface for displaying said output value to a user.

16. The method of claim 13 further comprising the step of transmitting said output value over said telephone line to a network.
